(19) United States
(12) Patent Application Publication
(10) Pub. No.: US 2003/0083967 A1
(43) Pub. Date: May 1, 2003

(54) Hand-held electronic checkbook

(75) Inventor: Samuel H. Fleming, Folsom, CA (US)

Correspondence Address: MARGER JOHNSON & McCOLLOM, P.C., 1030 SW MORRISON STREET, PORTLAND, OR, 97205, US

(73) Assignee: Intel Corporation, Santa Clara, CA

(21) Appl. No.: 10/001,463

(22) Filed: Oct. 29, 2001

(51) Int. Cl. G06F 17/60

(52) U.S. Cl. 705/33

(57) ABSTRACT

Described herein are a hand-held electronic checkbook and methods for using the electronic checkbook to write electronic checks and reconcile remote financial accounts. The electronic checkbook allows the user to configure settings so that each check requires the user to complete only two check fields with the electronic checkbook completing the remainder. Reconciling remote financial accounts occurs via Internet up-link through the input/output port on the electronic checkbook.

### BACKGROUND OF THE INVENTION

The disclosure relates generally to hand-held computing devices, and more particularly to a method and apparatus for using an electronic checkbook. The electronic checkbook is intended to replace the typical paper and pen checkbook carried by consumers.

Paper checkbooks are known in the art. However currently checkbook users must manually add deposits and subtract debits. As a result, errors are made and account balances are inaccurately reflected. The result is that users can be unaware of their true account balances, which can result in bounced checks, credit reporting difficulties and costly overdraft fees. Paper checkbooks also result in translation problems as individual handwriting quality varies.

Check writing software is also known in the art. The software is usually loaded onto a user's home computer for use in printing checks in the home. Limitations of software-based check writing are that the user is unwilling or unable to transport his computer and printer each time he needs to write a check. The result is that the user ends up using the paper checkbook while he is out and about, and he uses his software-based check writing program while at home. This dual usage requires the user to be vigilant in cross-recording his transactions to ensure that his account balance is accurately maintained at all times.

### BRIEF DESCRIPTION OF THE DRAWINGS

FIG. 1 is a schematic block diagram of an embodiment of the electronic checkbook.

FIG. 2 is an illustration of a physical embodiment of the electronic checkbook.

FIG. 3 is a check template that can be rendered on a display or on a printed check.

FIG. 4 is an illustration of an embodiment of the electronic checkbook's setup/configuration menu items.

### DETAILED DESCRIPTION OF THE INVENTION

The disclosure involves a touch-sensitive LCD attached to a small microcontroller-powered computer. The electronic checkbook also comprises a printer capable of printing check-sized documents. The user inputs data into the electronic checkbook by touching the sensitive LCD screen, typing into the keyboard or using an electronic pen or stylus to activate a simulated keyboard.

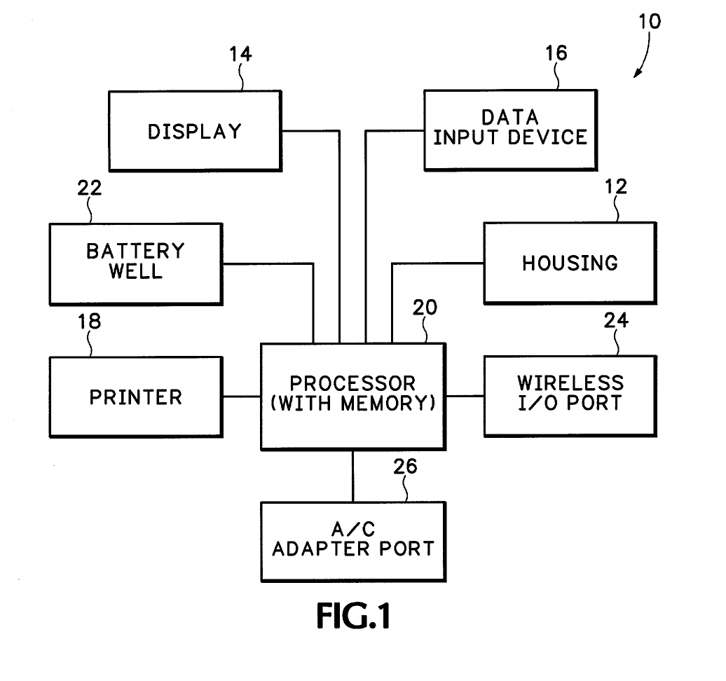

FIG. 1 is a schematic block diagram of an embodiment of the electronic checkbook 10. In this embodiment the electronic checkbook 10 comprises a housing 12, a user display 14, a data input device or keyboard 16, a printer 18, a processor 20 and a battery well 22. The electronic checkbook 10 also has a wireless input/output port 24 and an A/C adapter port 26. The housing 12 is small enough such that the electronic checkbook 10 is a hand-held device that can fit into a briefcase or a purse and comprises plastic or metal to provide support and protection for the electronics contained within. The housing contains the display 14, data input device 16, printer 18 and processor 20.

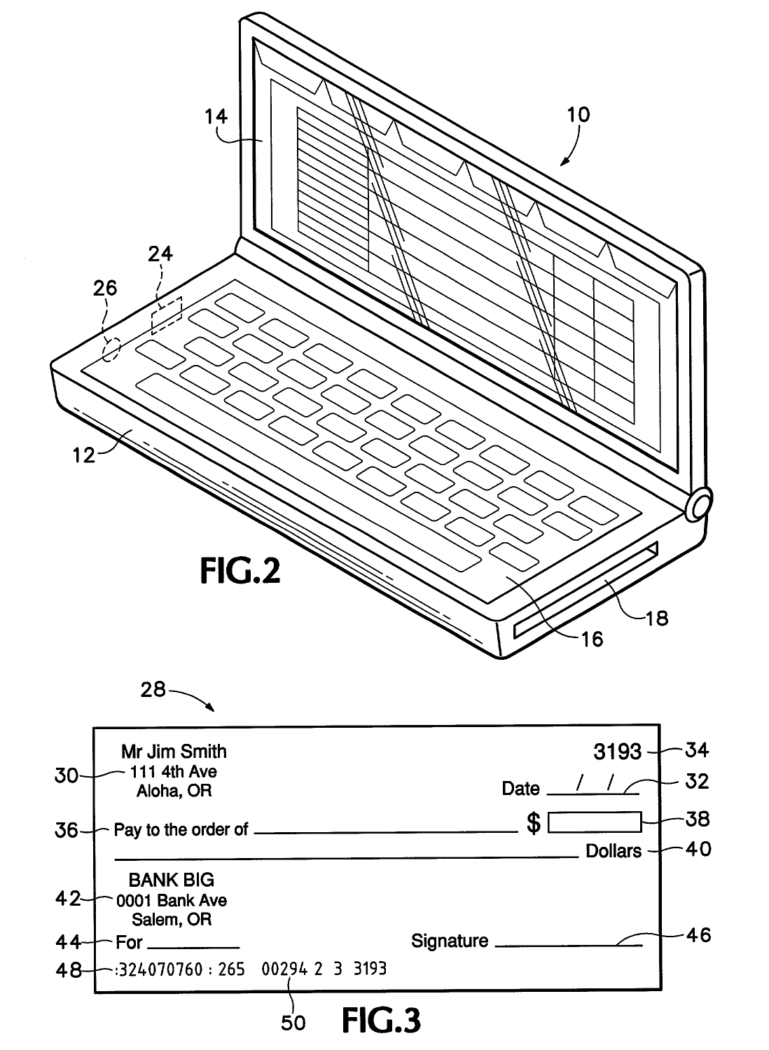

FIG. 2 is an illustration of a physical embodiment of the electronic checkbook. The user display 14 is a flip-up display embedded in the upper half of the housing 12. The display 14 displays familiar check registry information that tracks the check number, check date, check amount, current balance and whether the particular check has been reconciled. The display 14 also contains drop down menus for user-configured categories including a setup menu, payee favorites, memo favorites, a to-do list, check background favorites, and dial-up information. The user display 14 can be a touch-sensitive LCD screen or any other suitable display.

The data input device 16 is embedded in the base of the housing 12 and is visible when the display 14 is flipped up. The data input device 16 can be a touch-sensitive LCD and is composed of alphabetic and numeric characters, in addition to common keys appearing on basic calculators supporting functions such as add, subtract, multiply, and divide. The data input device 16 can also be a standard keyboard or a simulated keyboard for use with an electronic pen or stylus.

The printer 18 is located below the data input device 16 in the base of the housing 12. The printer 18 is not visible to the user other than an opening where the electronic check is printed. The print command, key or icon for the printer 18 can be located on the data input device 16 or the display 14.

The processor 20 is also embedded in the base of the housing 12 below the data input device 16 and is not visible to the user. The processor 20 is powered by batteries in the battery well 22 or by an A/C adapter 26.

FIG. 3 is a check template 28 that can be rendered on a display or on a printed check. The check template 28 contains fields for completion, some of which are completed by a user with the remainder being completed by the electronic checkbook. These fields include: the user's name and address 30, the date 32, the check number 34, the payee line 36, the dollar amount in numeric form 38, the dollar amount in text form 40, the user's bank information 42, the memo line 44, the signature line 46, and the routing information 48 containing the user's bank account number 50. With the exception of the memo line 44, these fields must generally be completed prior to presentment for payment at a bank.

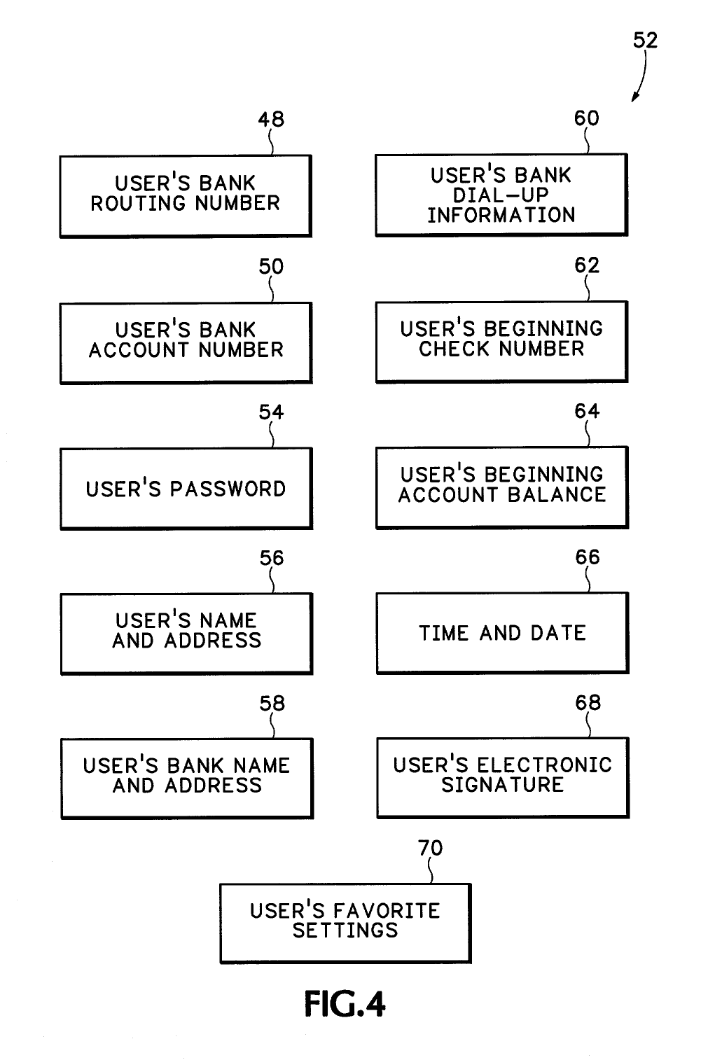

FIG. 4 is an illustration of setup/configuration menu items 52. The user configures the electronic checkbook 10 with user identifying information such as the user's password 54, the user's name and address 56, the user's bank or other financial institution name and address 58, the user's account number 50, the user's financial institution routing number 48, the user's financial institution dial-up information 60, the user's beginning check number 62, and the user's beginning account balance 64. If not already preset in the electronic checkbook 10 the user will also enter the date and time 66. The setup/configuration menu 52 can also support an electronic signature 68 and user favorite settings 70.

### EXAMPLES OF USE

Those with skill in the art will appreciate that the electronic checkbook 10 can use any suitable paper, including single sheets of paper and rolls of paper. In addition, the printer can be any type of printer 18 that can be housed in a hand-held device.

The advantages of the electronic checkbook 10 are many. With the electronic checkbook 10, the account balance is automatically calculated after each check is written or each deposit made. The updated account balance is immediately available to the user. As a result, fewer users will overdraft their accounts resulting in a savings of costly overdraft fees. The checks printed by the electronic checkbook 10 are also printed and are easier to read, resulting in fewer translation errors.

Paper checkbooks are also time consuming. To complete check writing with a paper checkbook, the user must fill out each field of the check prior to signing the check. The electronic checkbook 10 requires the completion of only two fields, the payee line 36 and the numeric amount of the check 38. These check fields can be completed by typing the data into a keyboard 16 or a touch-sensitive LCD display 14, or by writing the data with an electronic pen or stylus (known but not shown). Alternatively, the user can make selections from pull-down menus (known but not shown). The electronic checkbook 10 automatically inserts the remaining information. After the required data has been entered the user can select a print command from the data input device 16 or the display 14 and can print the electronic check directly from the electronic checkbook 10. The electronic check can be signed after it is printed.

In an additional embodiment, the electronic check can be signed before printing using an electronic signature 68. The electronic signature 68 can be a digital signature created with the use of an electronic pen and can be stored in the electronic checkbook. The electronic signature can also be a biometric adopted as a digital signature, for example, a digital version of the user's thumb-print.

In an embodiment of the invention, the payee line 36 can be completed by selecting among one or more favorite entities from a group of favorites stored in the electronic checkbook 10. The memo line 36 can also be completed by selecting from a group of favorite choices. This feature allows a user to keep better track of how funds are spent. For example the check might be for rent/mortgage, car payment, car insurance, groceries, clothing, or entertainment. Additional customized memo options may be created.

With paper checkbooks, users must purchase preprinted check blanks, usually from their banks. If the user moves or changes account information, he must order new checks. With the electronic checkbook 10, account information changes such as name, address, telephone number, financial institution, and account number can be changed electronically using a setup/configuration menu 52. Users need not order preprinted checks or incur additional fees with each change of account information.

An additional advantage of the electronic check is that users can select different check formats from the setup/configuration menu 52. This provides the user with flexibility in choosing check styles and saves the user money from not having to order numerous check styles from the financial institution or other check blank vendor.

In another embodiment the electronic checkbook 10 can store several account numbers representing different accounts as well as descriptions of the various accounts. For example a user might have a checking account and a savings account. Users of the electronic checkbook can write checks or view account balances from multiple accounts on a single electronic checkbook.

The electronic checkbook can, by way of an optional Internet up-link through a wireless input/output port 24, transmit and receive data. Those of skill in the art will appreciate that the input/output port need not be wireless. This feature allows the user to synchronize the electronic checkbook 10 to the user's checking or savings account. The electronic checkbook 10 supports an optional “reconcile the checkbook” function to ensure that the financial institution's records and the electronic checkbook's records match. Differences in account balances can be brought to the user's attention, and in one embodiment the electronic checkbook balance can be corrected to correspond to the financial institution's balance. Paper checkbooks, on the other hand, must be manually balanced or have balances maintained on a separate system.

An additional embodiment of the electronic checkbook 10 allows the user to configure auto-deposits and auto-withdrawals on given dates. For example a car payment that was automatically deducted on the 1^{st} and 15^{th} days of the month would appear as a deduction on the electronic checkbook on those dates. With paper checkbooks, a user must remember to enter this information and the entry must be done manually. Likewise a user with automatic payroll deposit would automatically have his standard payroll amount appear as a deposit on the payday.

A further embodiment of the electronic checkbook allows the user to configure a to-do list that has the capability to use the display 14 to prompt the user through a series of checks on demand that represent repetitive expenditures. These checks on demand represent checks that the user must write each month. Examples of such checks include: rent/mortgage, car payment, car insurance, groceries, and entertainment expenses.

The electronic checkbook 10 also has security superior to paper checkbooks. Paper checkbooks can be used by unauthorized parties who can also write forged checks. Thus, the electronic checkbook 10 preferably requires entry of a password before information is available to a user. Alternative embodiments use stored digital signatures or biometric identification in conjunction with electronic checkbook security.

In addition to functioning as an electronic checkbook 10, the electronic checkbook 10 can also be used to store phone numbers, dates, calendar entries and addresses. Additionally, the electronic checkbook 10 has a built-in calculator (not shown) that can be used for applications beyond account balancing. For example, the calculator allows simple or more complex banking-related or other functions, e.g. loan or mortgage amortization, present and future investment valuation, etc.

Finally, those of skill in the art will appreciate that the invented method and apparatus described and illustrated herein may be implemented in software, firmware or hardware, or any suitable combination thereof. Preferably, the method and apparatus are implemented in a combination of hardware and firmware, for purposes of low cost and flexibility. Thus, those of skill in the art will appreciate that parts of the method and apparatus of the invention may be implemented by a computer or microprocessor process in which instructions are executed, the instructions being stored for execution on a computer-readable medium and being executed by any suitable instruction processor. Alternative embodiments are contemplated, however, and are within the spirit and scope of the invention.

Having described and illustrated the principles of the invention in a preferred embodiment thereof, it should be apparent that the invention can be modified in arrangement and detail without departing from such principles. I claim all modifications and variation coming within the spirit and scope of the following claims.

1. A hand-held electronic checkbook apparatus comprising:
an input device for receiving financial data from a user;
a housing to contain electronics; and
a printing device for printing an electronic check at the electronic checkbook.

2. The apparatus of claim 1, further comprising a display for displaying data to the user.

3. The apparatus of claim 2, in which the input device is a touch-sensitive LCD.

4. The apparatus of claim 2, in which the input device is a keyboard.

5. The apparatus of claim 4, in which the keyboard is simulated and rendered on a display, for operating the simulated keyboard.

6. A hand-held electronic checkbook apparatus comprising:
an input device for receiving financial data from a user;
a display device for displaying data to the user;
a processor for manipulating the data from the user;
a printing device for printing an electronic check at the electronic checkbook; and
a housing to contain electronics, including the processor.

7. The apparatus of claim 6, in which the display device is a touch-sensitive LCD.

8. The apparatus of claim 6, further comprising an input/output port capable of transmitting and receiving data.

9. The apparatus of claim 8, further comprising an Internet up-link that allows synchronization of electronic checkbook data and actual financial account data maintained by a financial institution remote from the user.

10. The apparatus of claim 9, further comprising a reconcile the checkbook function.

11. A method for writing an electronic check on a hand-held electronic checkbook apparatus comprising:
procuring the electronic checkbook;
entering data into predefined fields in an intangible form for printing the electronic check on a tangible medium at the electronic checkbook; and
printing the electronic check.

12. The method of claim 11, in which the data is financial data of a user.

13. The method according to claim 12, in which a first field is a payee field and a second field is a numeric amount field.

14. The method according to claim 13, further comprising applying a signature to the electronic check after printing.

15. The method according to claim 13, further comprising applying a digital signature to the electronic check prior to printing.

16. A method for writing an electronic check on a hand-held electronic checkbook apparatus comprising:
procuring the electronic checkbook;
configuring the electronic checkbook for use by a user;
entering a first data into a payee field on the electronic checkbook;
entering a second data into a numeric amount field on the electronic checkbook; and
entering a print command for printing the electronic check at the electronic checkbook.

17. The method according to claim 16, further comprising applying a signature to the electronic check after printing.

18. The method according to claim 16, further comprising applying a digital signature to the electronic check prior to printing.

19. The method according to claim 16, further comprising configuring the electronic checkbook with a to-do list, the to-do list being characterized as recurring monthly checks of the user.

20. The method according to claim 19, in which a processor of the electronic checkbook prompts the user via a display to complete the to-do list.

21. The method according to claim 20, further comprising writing the electronic check in response to a prompt originated by the electronic checkbook.

22. A method for reconciling a remote financial account using a handheld electronic checkbook comprising:
procuring the electronic checkbook;
accessing the remote financial account;
selecting a reconcile the checkbook function on the electronic checkbook;
comparing the remote balance with a balance maintained by the electronic checkbook; and
identifying discrepancies between the remote balance and the balance maintained by the electronic checkbook.

23. The method of claim 22, in which the remote financial account is accessed through an input/output port, located at the electronic checkbook, capable of transmitting and receiving data.

24. The method of claim 23, further comprising correcting any discrepancies between the remote balance and the balance maintained by the electronic checkbook.

25. A method for reconciling a financial account of a user, remote from the user, using a hand-held electronic checkbook comprising:
procuring an electronic checkbook;
accessing a balance of the user maintained by a financial institution of the user;
selecting a reconcile the checkbook function on the electronic checkbook;
comparing the balance of the user maintained by the financial institution of the user with a balance of the user maintained by the electronic checkbook; and
alerting the user to any discrepancies between the balance maintained by the financial insitution of the user and the balance maintained by the electronic checkbook.

26. The method of claim 25, in which the balance of the user maintained by the financial institution of the user is accessed through an input/output port, located at the electronic checkbook, capable of transmitting and receiving data.

27. The method of claim 26, further comprising correcting any discrepancies between the balance maintained by the financial institution of the user and the balance maintained by the electronic checkbook.
